(19) United States
(12) Patent Application Publication
(10) Pub. No.: US 2006/0137484 A1
(43) Pub. Date: Jun. 29, 2006

(54) Rear power takeoff

(76) Inventors: John Martin Seipold, Glasford, IL (US); Kevin Gerard Meyer, Metamora, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/022,630

(22) Filed: Dec. 28, 2004

(51) Int. Cl. F16H 37/00; B60K 17/28; B60K 25/00

(52) U.S. Cl. 74/15.63; 180/53.1

(57) ABSTRACT

A system for transferring power from a work machine engine to a pump assembly of the work machine includes a power transfer assembly configured to transfer power to the pump assembly independent of transmission gear ratio. The pump assembly is mounted to a rear portion of a transmission of the work machine.

### TECHNICAL FIELD

This disclosure relates generally to a system and method for driving an auxiliary hydraulic pump and, more particularly, to a system and method for driving an auxiliary hydraulic pump located on a transmission of a machine.

### BACKGROUND

Conventional work machines can be used in many different applications, including those in the areas of construction, agriculture, landscaping, and mining. To perform these applications, work components are typically connected to work machine lift arms or other articulated members, which are actuated by one or more components of the work machine's auxiliary hydraulic circuit. For example, an auxiliary hydraulic circuit may include an auxiliary pump configured to supply fluid to the articulated members to facilitate movement of the members and the work components while an application is being performed.

In some work machines, output power directed through the transmission of the work machine from the engine may be used to drive elements of the auxiliary hydraulic circuit. One system used for transmitting power from a transmission to an auxiliary device is a power takeoff (PTO). In some work machines, PTO systems may be used to drive the auxiliary pumps of the auxiliary hydraulic circuit and may, thus, assist in actuating the articulated members of the work machine while a task is being performed. To facilitate power transmission, the auxiliary pumps used in many work machines may be mounted directly to a housing of the transmission.

For example, U.S. Pat. No. 5,492,034 (“the '034 patent”) to Bogema describes a number of PTO systems configured to transmit power to auxiliary pumps mounted to a rear wall of a transmission housing. The transmission of the '034 patent includes a main transmission section and an auxiliary transmission section, whereby the selected gear reduction in the main transmission section is compounded by further gear reduction in the auxiliary section. Multiple clutch and shaft configurations are used to transmit energy from an input shaft, driven by the engine, to the auxiliary pumps. For instance, countershafts are connected to the input shaft via a master clutch such that the countershafts only rotate when the master clutch is engaged. The countershafts are also clutched to secondary shafts used to drive the auxiliary pumps. Thus, the secondary shafts, and their respective pumps, only rotate when the master clutch and a secondary clutch are both engaged.

Although the PTO systems of the '034 patent may assist in taking off power from the transmission of the work machine, the systems do not drive the auxiliary pumps independent of transmission gear ratio. Instead, power transfer from the engine to the shafts used to drive the auxiliary pumps is dependent upon the engagement of one or more clutches. These clutches may, thus, interrupt the flow of power from the engine to the auxiliary pumps when the transmission changes gear ratio. The additional components required by such a compound transmission may also increase the cost of the system and the amount of space required to package the system within an engine compartment of the work machine.

The system of the present disclosure is directed to overcoming one or more of the problems set forth above.

### SUMMARY OF THE INVENTION

In one embodiment of the present disclosure, a system for transferring power from a work machine engine to a pump assembly of the work machine includes a power transfer assembly configured to transfer power to the pump assembly independent of transmission gear ratio. The pump assembly is mounted to a rear portion of a transmission of the work machine.

In another embodiment of the present disclosure, a system for driving a pump assembly of a work machine includes a power transfer assembly directly coupled to an output shaft of a work machine engine and configured to continuously drive the pump assembly at a rate proportional to engine speed. The pump assembly is connected to a rear portion of a transmission of the work machine.

In still another embodiment of the present disclosure, a method of driving a pump assembly mounted to a rear portion of a work machine transmission includes providing a power transfer assembly directly coupled to an output shaft of a work machine engine. The method further includes continuously driving the pump assembly at a rate proportional to engine speed during operation of the work machine engine.

### BRIEF DESCRIPTION OF THE DRAWINGS

FIG. 1 is an isometric view of a transmission having a rear-mounted auxiliary pump according to an exemplary embodiment of the present disclosure.

FIG. 2 is a partial cut-away view of the transmission of FIG. 1.

FIG. 3 is an isometric view of a transmission having a rear mounted auxiliary pump according to a second embodiment of the present disclosure.

### DETAILED DESCRIPTION

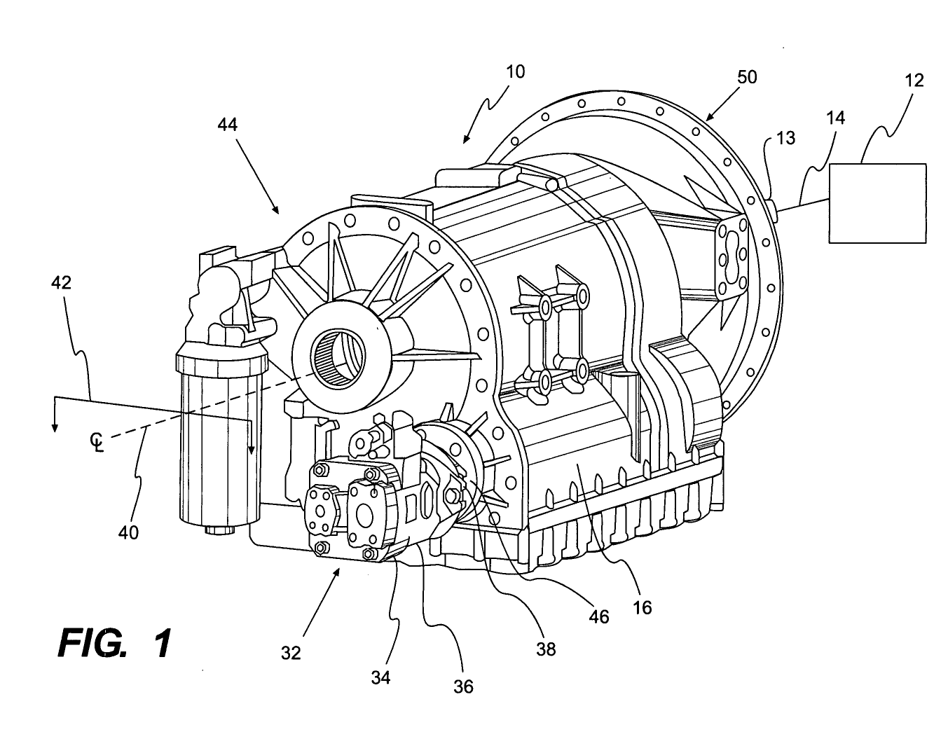

FIG. 1 illustrates a transmission 10 of an engine 12. The engine 12 may be, for example, an internal combustion engine or any other type of engine known in the art. The engine 12 and the transmission 10 may be mounted within an engine compartment of a work machine (not shown) and may be configured to supply power to elements of the work machine by any conventional means.

The transmission 10 may be connected to the engine 12 through any conventional means. In an exemplary embodiment, an input shaft 13 of the transmission 10 may be directly coupled to an output shaft 14 of the engine 12 using, for example, a conventional flexplate coupling, and may rotate at the same rotational speed as the output shaft 14. This direct coupling, may be accomplished by any conventional means such as, for example, a spline, a keyed joint, a constant velocity joint, a pressed fit, meshed gears, and/or other direct couplings known in the art. A pump assembly 32 useful in supplying hydraulic fluid to elements of the work machine may be mounted to a rear portion 44 of the transmission. As will be described in greater detail below, the pump assembly 32 may include a pumping mechanism 34 and a pump drive 36.

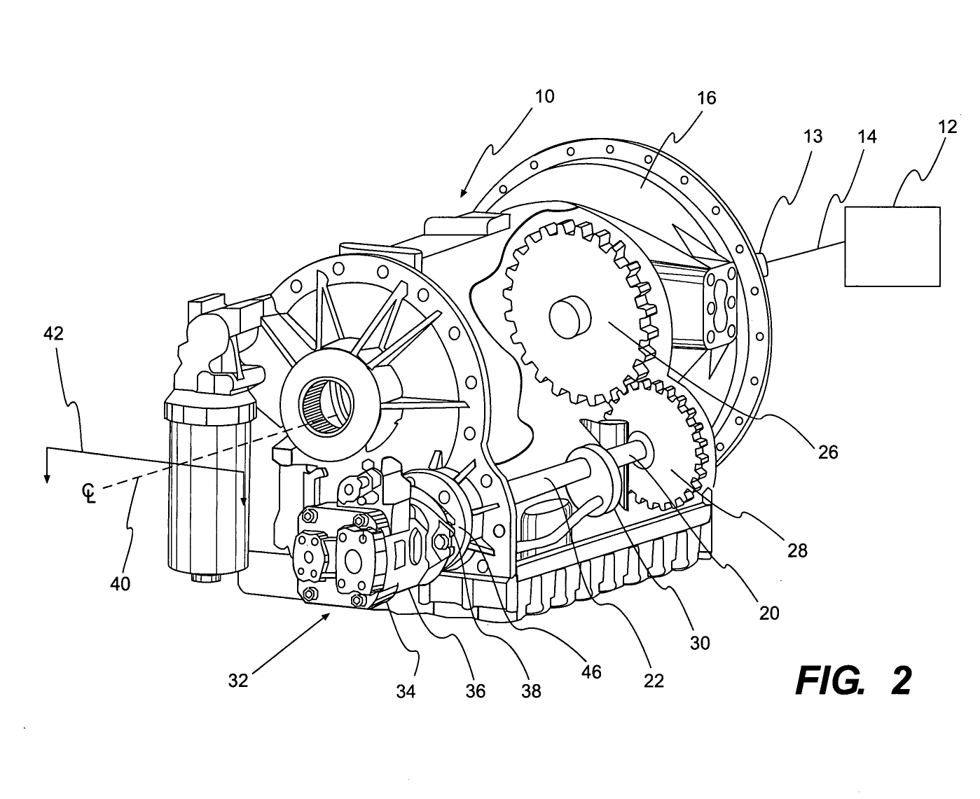

As shown in FIG. 2, the transmission 10 of the present disclosure includes an exemplary embodiment of a power takeoff (“PTO”) 18. The PTO 18 may be a power transfer assembly and may assist in transferring power from the engine 12 to the pump assembly 32. The PTO 18 may include a single shaft useful in transferring power or, alternatively, the PTO 18 may include two shafts, a drive-thru shaft 20 and a transmission shaft 22, to allow for easier assembly. The drive-thru shaft 20 may be shorter than the transmission shaft 22, and the length, diameter, and other characteristics of the shafts 20, 22 may be matters of design choice. For example, at least one of the shafts 20, 22 may be hollow to reduce weight and/or cost. The shafts 20, 22 may be made from any metal or alloy known in the art such as, for example, steel, aluminum, or titanium, and the shafts 20, 22 may be directly coupled to each other. The transmission shaft 22 may be dimensioned such that it mates with the pump assembly 32 so as to provide power thereto.

The PTO 18 may further include a driven gear 28. The driven gear 28 may be directly coupled to the drive-thru shaft 20 by any conventional means, such that the drive-thru shaft 20 rotates at the same rotational speed as the driven gear 28. The driven gear 28 may also be directly coupled to a drive gear 26 of the transmission 10 through, for example, an interlocking mesh between the drive gear 26 and the driven gear 28. As shown in FIG. 2, the drive gear 26 may be directly coupled to the input shaft 13 such that the drive gear 26 rotates at the same rotational speed as the input shaft 13 while the engine 12 is operating. Thus, the PTO 18 may be configured to transfer power from the engine 12 to the pump assembly 32.

Through the direct coupling between the drive gear 26 of the transmission 10 and the driven gear 28, the PTO 18 of the present disclosure is directly coupled to the engine 12 and is continuously driven by the engine 12 independent of transmission ratio or vehicle travel speed. The PTO 18 may be configured to continuously drive the components of the pump assembly 32 at a rate proportional to engine speed. As used herein, the term “continuous drive” is defined as a system that is driven without the use of a clutch mechanism. In such continuous drive systems, power may be transferred from a drive member to a driven member without interruption. In addition, as used herein, the term “PTO speed” refers to the rotational speed of the transmission shaft 22, the drive-thru shaft 20, and/or the driven gear 28. For example, the PTO 18 of the present disclosure may be used with either manual or automatic transmissions. Regardless of the design of the transmission 10, the PTO 18 may be directly coupled to components of the transmission 10 upstream of vehicle primary clutches or other clutching mechanisms such that power transferred by the PTO 18 to the pump assembly 32 of the work machine may not be interrupted when the gear ratio of the transmission 10 changes. In such a continuous drive system, the ratio of PTO speed to engine speed may remain substantially constant.

The drive gear 26 and the driven gear 28 may be made from steel or any other metal or alloy known in the art. The gears 26, 28 may be configured such that the ratio of engine speed to PTO rotational speed remains substantially constant during operation of the engine 12 and/or the work machine. The driven gear 28 may be sized and configured so as to drive the pump assembly 32 of the work machine at a desired rate. The size of each gear 26, 28 may also be constrained by the dimensions of the transmission housing 16 and the engine compartment (not shown).

The transmission 10 may further include a charge pump 30. The charge pump 30 may provide hydraulic power to elements of the transmission 10 for lubrication and/or clutch engagement. In one exemplary embodiment, the charge pump 30 may be disposed within the housing 16 of the transmission. In such an embodiment, at least a portion of the drive-thru shaft 20 may be disposed within the charge pump 30, and the drive-thru shaft 20 may be directly coupled to the transmission shaft 22 downstream of the charge pump 30. Passing a portion of the drive-thru shaft 20 through the charge pump 30 in such an embodiment may conserve space within the housing 16 of the transmission 10 and may make it easier to package the PTO 18 therein. In another exemplary embodiment, the charge pump 30 may be disposed in line with the transmission centerline 40 and may be driven directly by the input shaft 13. The charge pump 30 may be mounted in any conventional way, such as, for example, to the housing 16 in a location within or outside of the transmission 10. In such an embodiment, the drive-thru shaft 20 may be omitted. It is understood that the PTO 18 may be integral to the transmission. As used herein, the term “integral” is defined as being internal to, fully integrated with, and/or a part of another component.

As noted above, the pump assembly 32 of the present disclosure may include a pumping mechanism 34 and a pump drive 36. The components of the pump assembly 32 may be configured to supply hydraulic fluid to the hydraulic components of the work machine. Such hydraulic components may include, for example, articulating arms and may assist in performing a wide variety of applications. Accordingly, the pump assembly 32 may be part of an auxiliary hydraulic fluid circuit of the work machine.

The pumping mechanism 34 may be any type of hydraulic pump known in the art. The pumping mechanism 34 could be a displacement pump of either the reciprocating power or rotary design. It is intended that the category “rotary displacement pump” include both single and multiple rotor versions of valve, piston, flexible valve, lobe, gear, gerotor, circumferential piston and screw type pumps. In addition, the pumping mechanism 34 could be a centrifugal pump of the radial, mixed or axial flow design, or any other type of fluid delivery pump not explicitly mentioned herein. In an exemplary embodiment of the present disclosure, the pumping mechanism 34 may be a positive displacement pump. The pumping mechanism 34 may be sized based on the flow of hydraulic fluid required to perform the desired task. For example, the flow of hydraulic fluid required to power articulating members used to empty a dump truck body may require a larger pumping mechanism 34 than the pumping mechanism 34 required to operate a cooling fan.

The pump drive 36 may be any type of pump drive known in the art and may include internal gearing appropriate for increasing or decreasing the rotational speed of the pumping mechanism 34 as the pump drive 36 is driven by the transmission shaft 22. In an embodiment, the pump drive 36 may include a gear box of a type known in the art. It is understood that the pump drive 36 may be directly coupled to the transmission shaft 22.

As shown in FIG. 1, the transmission 10 may include a front portion 50 and a rear portion 44. The input shaft 13 of the transmission 10 may be directly coupled to the output shaft 14 of the engine 12 proximate the front portion 50, while the pump assembly 32 may be mounted to the rear portion 44 at the location of a flange 46. For example, the pumping mechanism 34 and the pump drive 36 may be mounted directly to the rear portion 44 by way of an adapter 38 configured to mount to the flange 46. The adapter 38 may sealidly connect the pump assembly 32 to the flange. In such an embodiment, the pumping mechanism 34 may operate, and may supply hydraulic power to elements of the work machine, whenever the engine is running. In embodiments where the pump assembly 32 and the flange 46 include corresponding mating surfaces, however, the adapter 38 may be omitted.

The PTO 18 may be configured to continuously drive the pump assembly 32 at a rate proportional to engine speed. The ratio of engine speed to PTO speed may, thus, remain substantially constant during the operation of the work machine. Such an embodiment may be useful in, for example, a work machine having a cooling fan that requires a constant supply of hydraulic fluid.

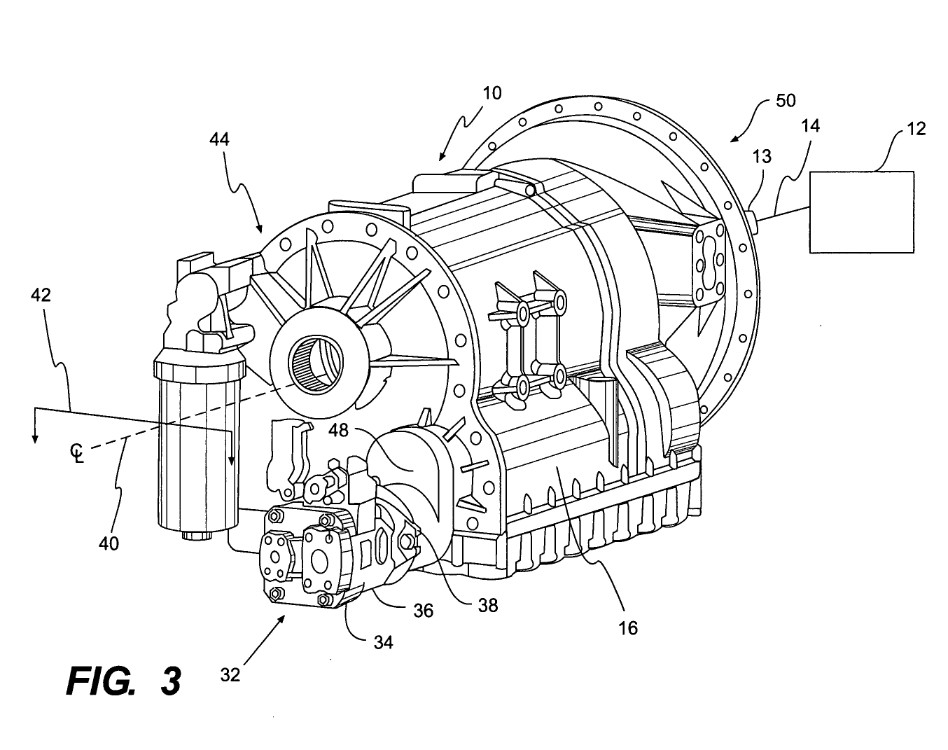

As shown in FIG. 3, the pump assembly 32 may further include a clutch 48 of a type known in the art. The clutch 48 may be, for example, an on/off clutch. Together, the pump drive 36 and clutch 48 may enable the user to vary and/or change the output of the pumping mechanism 34 based on the application being performed. Such a configuration may also enable the user to direct power to hydraulic components of the work machine as desired. For example, a dump truck operator may only require hydraulic power in the articulating arms of the truck when raising the dump body to unload. The clutch 48 may be engaged to provide the necessary power from the pumping mechanism 34. Conversely, when the operator is merely driving the dump truck, no hydraulic power is needed in the arms and the clutch 48 may be disengaged. It is understood that in such an embodiment, engaging and disengaging the clutch 48 may change the proportion of engine speed (and PTO speed) to pump assembly speed. However, actuating the clutch 48 does not alter PTO speed. Thus, in this embodiment, the ratio of engine speed to PTO speed may remain substantially constant during the operation of the work machine.

Referring again to FIG. 2, the transmission 10 may have a centerline 40 extending along a longitudinal axis of the input shaft 13 and a horizontal plane 42 may pass through the centerline 40. In an exemplary embodiment of the present disclosure, the PTO 18 may be disposed below the centerline 40 of the transmission 10 (i.e., below the horizontal plane 42 as designated by the arrows shown in FIG. 2). For example, as shown in FIG. 2, the transmission shaft 22 and the drive-thru shaft 20 may be disposed below the horizontal plane 42 as measured from the centerline 40. In particular, the shafts 20, 22 and the pump assembly 32 may be disposed in a lower side quadrant of the rear portion 44 of the transmission.

### INDUSTRIAL APPLICABILITY

The disclosed PTO 18 may be used with any work machine known in the art having articulated members and/or other components actuated by compressed hydraulic fluid. Such work machines may include, for example, on-highway class 6, 7, and 8 trucks, such as garbage trucks, dump trucks, and long-haul freight trucks. Such work machines may also include any off-highway vehicle. It is understood that the disclosed PTO 18 may also be used with any other on-highway vehicle such as, for example, recreational vehicles and transit busses.

As described above, the PTO 18 may assist in transferring power from the engine 12 to, for example, the pumping mechanism 34 and the pump drive 36 of the pump assembly 32. The PTO 18 may transfer power independent of transmission gear ratio. This independent power transfer may be possible due to the direct coupling between the PTO 18 and the output shaft 14 of the engine 12. As discussed above, this direct coupling includes the couplings between the input shaft 13, the output shaft 14, the drive gear 26, the driven gear 28, the transmission shaft 22, and the drive-thru shaft 20. The PTO 18 is, thus, configured to continuously drive the pump assembly 32 without power interruptions caused by transmission clutch mechanisms located upstream of the PTO 18.

The engine compartments of the work machines utilizing the PTO 18 of the present disclosure may be severely constrained due to the presence of machine suspension components, exhaust routing, and other engine components. These components may typically be located near the front portion 50 of the transmission. Thus, locating the PTO 18 components as described above may assist in packaging, for example, the pump assembly 32 within the engine compartment and/or vehicle chassis of the work machine.

The PTO 18 drives the pump assembly 32 at a speed directly proportional to engine speed due to the direct coupling. The PTO 18 drives the pump assembly 32 whenever the output shaft 14 of the engine 12 is rotating. The proportion of PTO speed to pumping mechanism speed may be modified by a pump drive 36, either alone or in conjunction with a clutch 48, as desired for a particular application. The ratio of PTO speed to engine speed, however, may be held substantially constant due to the direct couplings and continuous drive configurations described herein. In embodiments where a clutch 48 is included downstream of the PTO 18, the ratio of pump assembly speed to engine speed may change as the clutch 18 is engaged and disengaged.

Other embodiments of the disclosure will be apparent to those skilled in the art from consideration of the specification. For example, in an embodiment of the present disclosure, the pump assembly 32 may be omitted. In such an embodiment, the transmission shaft 22 may be directly coupled to a small drive shaft. The drive shaft and/or the transmission shaft 22 may be supported by a bearing support disposed proximate the flange 46. Such an embodiment may be useful in applications involving an accessible source of rotational power such as, for example, powering a winch or a high speed fan.

In another exemplary embodiment, the pump assembly 32 may be mounted downstream of the transmission 10 to, for example, a frame of the vehicle. In such an embodiment, the drive shaft 22 may extend to the rear portion 44 of the transmission 10 and may connect to a conventional yoke or other universal connection device. A connector shaft may extend from the yoke to the pump assembly 32, and may be directly coupled to, for example, the pump drive 36.

It is intended that the specification and examples be considered as exemplary only, with the true scope of the invention being indicated by the following claims.

What is claimed is:

1. A system for transferring power from a work machine engine to a pump assembly of the work machine, comprising:
a power transfer assembly configured to transfer power to the pump assembly independent of transmission gear ratio, the pump assembly being mounted to a rear portion of a transmission of the work machine.

2. The system of claim 1, wherein the power transfer assembly is integral to the transmission of the work machine.

3. The system of claim 1, wherein the power transfer assembly is directly coupled to an output shaft of the work machine engine.

4. The system of claim 1, wherein the power transfer assembly includes a drive-thru shaft directly coupled to a transmission shaft, and the transmission shaft is directly coupled to a component of the pump assembly.

5. The system of claim 4, wherein at least a portion of the drive-thru shaft is disposed within a charge pump of the transmission.

6. The system of claim 1, wherein the power transfer assembly is disposed beneath a horizontal plane passing through a centerline of the transmission.

7. The system of claim 1, wherein the pump assembly includes a pumping mechanism and a pump drive.

8. The system of claim 7, wherein the pump drive includes a gear box configured to drive the pumping mechanism at a desired rate.

9. The system of claim 8, wherein the pump drive further includes a clutch configured to control an output of the pumping mechanism.

10. The system of claim 8, wherein the pumping mechanism comprises a positive displacement pump.

11. The system of claim 8, wherein the ratio of engine speed to power transfer assembly speed remains substantially constant during operation of the work machine engine.

12. A system for driving a pump assembly of a work machine, comprising:
a power transfer assembly directly coupled to an output shaft of a work machine engine and configured to continuously drive the pump assembly at a rate proportional to engine speed, the pump assembly being connected to a rear portion of a transmission of the work machine.

13. The system of claim 12, wherein the power transfer assembly is integral to the transmission of the work machine.

14. The system of claim 12, wherein the power transfer assembly includes a drive-thru shaft directly coupled to a transmission shaft, and the transmission shaft is directly coupled to a component of the pump assembly.

15. The system of claim 12, wherein the power transfer assembly is disposed beneath a horizontal plane passing through a centerline of the transmission.

16. The system of claim 12, wherein the pump assembly includes a pumping mechanism and a pump drive.

17. The system of claim 16, wherein the pump drive comprises a gear box configured to drive the pumping mechanism at a desired rate.

18. The system of claim 16, wherein the pumping mechanism comprises a positive displacement pump.

19. The system of claim 12, wherein the proportion of engine speed to power transfer assembly speed remains substantially constant during operation of the work machine engine.

20. A method of driving a pump assembly mounted to a rear portion of a work machine transmission, comprising:
providing a power transfer assembly directly coupled to an output shaft of a work machine engine; and
continuously driving the pump assembly at a rate proportional to engine speed during operation of the work machine engine.

21. The method of claim 20, further including holding the ratio of engine speed to power transfer assembly speed substantially constant during operation of the work machine engine.

22. The method of claim 20, further including providing a drive-thru shaft directly coupled to a transmission shaft, wherein the transmission shaft is directly coupled to a component of the pump assembly.

23. The method of claim 20, wherein the power transfer assembly is disposed beneath a horizontal plane passing through a centerline of the transmission.

24. The method of claim 20, wherein the pump assembly includes a pumping mechanism and a pump drive.

25. The method of claim 24, wherein the pumping mechanism comprises a positive displacement pump.

26. The method of claim 24, further including providing a clutch configured to change the proportion of power transfer assembly speed to pump assembly speed.
